(19) United States
(12) Patent Application Publication
(10) Pub. No.: US 2014/0282665 A1
(43) Pub. Date: Sep. 18, 2014

(54) SET TOP BOX COOKIES

(71) Applicant: Nick Salvatore Arini, Southampton (GB)

(72) Inventor: Nick Salvatore Arini, Southampton (GB)

(21) Appl. No.: 13/843,834

(22) Filed: Mar. 15, 2013

(51) Int. Cl. H04N 21/8358; H04N 21/81

(52) U.S. Cl. CPC H04N 21/8358; H04N 21/812
USPC 725/18; 725/32

(57) ABSTRACT

A method, executed by a processor, for serving sponsored content at a second media device associated with a first media device includes receiving by a processor, a unique identification of the first media device; storing the unique identification with the second media device; sending, by the processor, a sponsored content request and the unique identification to a sponsor; receiving, by the processor, sponsored content selected based on historical data related to the content viewed on the first media device.

### BACKGROUND

“Cookies,” small files stored on an Internet client as a result of a visit by the client to a Web site, enable Web site servers to obtain a priori knowledge of previous Web site visits by the client. This “prior knowledge” helps Web site servers “remember” the client's preferences and other information. When the client revisits the same Web site for which cookies are stored, the Web site server reads the cookies, and may use the data read from the file to more easily provide relevant content to the client during the current client visit. As cross-media usage become more common (the center of which may be a shared space in a home, such as a living room) having similar a priori information about media exposure between or among different platforms may become useful. In some circumstances, direct communication between media devices (for example, an Internet-enabled television and a second screen client such as a tablet) is possible. However, currently, no standard exists for such direct communication.

### SUMMARY

A method, executed by a processor, for serving sponsored content at a second media device associated with a first media device includes receiving by a processor, a unique identification of the first media device; storing the unique identification with the second media device; sending, by the processor, a sponsored content request and the unique identification to a sponsor; receiving, by the processor, sponsored content selected based on historical data related to the content viewed on the first media device.

### DESCRIPTION OF THE DRAWINGS

The detailed description refers to the following Figures in which like numerals refer to like items, and in which:

FIG. 1 illustrates an example environment in which media exposure information on a first media device is used in a process for selection of sponsored content on a second media device;

FIGS. 2A and 2B illustrate example relationships among media devices operating in the environment of FIG. 1; and

FIGS. 3A and 3B illustrates example methods of serving sponsored content in the environment of FIG. 1.

### DETAILED DESCRIPTION

“Cookies,” typically small files stored on an Internet client as a result of a visit by the client to a Web site, enable Web site servers to obtain a priori knowledge of previous Web site visits by the client. This “prior knowledge” helps Web site servers “remember” the client's preferences and other information. When the client revisits the same Web site for which cookies are stored, the Web site server reads the cookies, and may use the data read from the file to more easily provide relevant content to the client during the current client visit. One use of such cookies is as an input to an advertisement selection process where an advertisement is selected to be served at the client.

As cross-media usage become more common (the center of which may be a shared space in a home, such as a living room) having similar a priori information about media exposure between or among clients may be useful. In some circumstances, direct communication between clients, or media devices (for example, an Internet-enabled television and a second screen client such as a tablet), is possible, and this direct communication may be exploited to share the a priori information.

This inter-client, or inter-device, communication, for which no standard currently exists, may be exploited to enhance delivery of certain media (e.g., video programs, sponsored content) to a second media device based on media exposure at first media device as communicated by the first media device to a second media device. The herein disclosed systems and method provide this inter-device communication and media exposure coordination by detecting and storing media exposure on the first media device and communicating that exposure to the second media device. In an embodiment, the first media device is a television set top box (STB) and the second media device is a tablet or smart phone.

In an aspect of this embodiment, the two media devices communicate using a direct Internet Protocol (IP) connection. One such way to establish this IP connection between media devices is by using Bluetooth technology.

In another aspect of this embodiment, the two media devices communicate using a remote IP connection through a third party. For example, the television STB is connected to the Internet and communicates to a remote server, which in turn communicates to the second media device, which is local to the television STB.

In yet another aspect of this embodiment, the television to which the STB is coupled emits audio, which may be detected and interpreted at the second media device.

This aspect of the embodiment may employ different audio detection and interpretation mechanisms and techniques. A first mechanism and corresponding technique detects a normal audio signal coming from the television during, for example, display of a broadcast television program. The first mechanism may include a microphone installed on the second media device. The microphone detects the audio; programming or logic on the second media device processes and temporarily stores the collected audio signal; other programming or logic creates an audio “fingerprint” of the stored audio. The audio fingerprint may be used to synchronize second media device applications and media measurement. The audio fingerprint may be provided to a remote analytics service to identify the television media that emitted the underlying audio.

A second mechanism and corresponding technique employs tones that are inserted into the broadcast content television media and that then are detected by software in a metering device. The technique encodes information into the audio tone. In the television STB, a tone generator generates the audio tone(s). A tone, or series of tones, may be modulated to contain information about a unique identification of the television STB. The tone(s) may encode an identification of the television STB (STB ID). The STB then inserts the tone(s), with the encoded STB ID into the broadcast television stream. The STB may insert the STB ID-bearing tone at regular intervals or on demand.

In an embodiment, the systems may log media consumption data on the television STB. The television STB may provide the logging data to a remote server over a “backchannel.”

At the remote server, the logging data are processed to produce media exposure information (i.e., viewing data related to television programs and advertisements, for example). The remote server may use the media exposure information to create a database of exposures that are linked to the unique STB identification. In this way, the television STB, in effect, takes the role of a browser in terms of storing previous visit (viewing) history, and the STB ID takes the role of an Internet “cookie.”

With this database established, and the analogous relationship of the television STB to an Internet browser in place, when a second screen media device (in the above example, a tablet) requests an ad server serve the tablet an advertisement, the tablet acquires the STB ID (the cookie analogy) by one of the example mechanisms disclosed above (e.g., audio sampling and fingerprinting), which encode the STB ID. The tablet then provides the STB ID to the ad server.

The ad server may use the STB ID to retrieve television programs watched and advertisement exposure information as an a priori input to an advertisement selection process when serving ad to the tablet.

To enhance a viewer's media consumption experience, disclosed herein are systems and methods that store small files, or cookies” on a “smart” television or on a television set top box (STB).

FIG. 1 illustrates an example environment in which media exposure information on a first media device is used in a process for selection of sponsored content on a second media device. In FIG. 1, environment 10 includes viewing locations 20, sponsor 40, program provider 60, and analytics service 70, all of which communicate using communications network 50. Although FIG. 1 shows these entities as separate and apart, at least some of the entities may be combined or related. For example, the sponsor 40 and program provider 60 may be part of a single entity. Other combinations of entities are possible.

The viewing location 20 includes first media device 24 and second media device 26 through which viewers 22 are exposed to media from sponsor 40 and program provider 60. A viewing location 20 may be the residence of the viewer 22, who operates media devices 24 and 26 to access, through router 25, resources such as Web sites and to receive television programs, radio programs, and other media. In an aspect disclosed herein, the viewer 22 is a recruited panelist.

The media devices 24 and 26 may be fixed or mobile. For example, media device 24 may be an Internet connected “smart” television (ITV); a “basic” or “smart” television connected to a set top box (STB) or other Internet-enabled device; a Blu-ray™ player; a game box; and a radio, for example. Media device 26 may be a tablet, a smart phone, a laptop computer, or a desk top computer, for example. The media devices 24 and 26 may include browsers. A browser may be a software application for retrieving, presenting, and traversing resources such as at the Web sites. The browser may record certain data related to the Web site visits. The media devices 24 and 26 also may include applications. The panelist 22 may cause the media devices 24 or 26 to execute an application, such as a mobile banking application, to access online banking services. The applications may involve use of a browser or other means, including cellular means, to connect to the online banking services.

The viewing location 20 may include a monitor 27 that records and reports data collected in connection with request for and delivery of sponsored content segments 42 and programs 62 to the panelist 22. The example monitor 27 may be incorporated into router 25 through which certain media (e.g., Internet-based content and content requests) received at or emanating from the viewing location 20 passes.

The sponsor 40 operates server 44 to provide sponsored content segments that are served with programs 62 provided by the program provider 60. For example, the server 44 may provide sponsored content segments to serve with broadcast television programming. The sponsored content segments 42 may include audio, video, and animation features. The sponsored content segments 42 may be in a rich media format. The sponsor 40 may provide a promotional campaign that includes sponsored content segments to be served across different media types or a single media type. The cross-media sponsored content segments 42 may be complementary; that is, related to the same product or service.

The network 50 may be any communications network that allows the transmission of signals, media, messages, voice, and data among the entities shown in FIG. 1, including radio, linear broadcast (over-the-air, cable, and satellite) television, on-demand channels, over-the-top media, including streaming video, movies, video clips, and games, and text, email, and still images, and transmission of signals, media, messages, voice, and data from a media device to another media device, computer, or server. The network 50 includes the Internet, cellular systems, and other current and future mechanisms for transmission of these and other media. The network 50 may be both wired and wireless. The network 50 may be all or a portion of an enterprise or secured network. In an example, the network 50 may be a virtual private network (VPN) between the program provider 60 and the media devices 24 and 26. While illustrated as a single or continuous network, the network 50 may be divided logically into various sub-nets or virtual networks, so long as at least a portion of the network 50 may facilitate communications among the entities of FIG. 1.

The program provider 60 delivers programs for consumption by the panelist 22. The programs 62 may be streaming video programs from Internet Web sites. The programs 62 may be delivered to the media devices 24 and 26 as encrypted data packets using public key encryption. The programs 62 may include provisions for serving and displaying sponsored content segments 42. The program provider 60 may receive the sponsored content segments 42 from the sponsor and incorporate the sponsored content segments into the programs 62. Alternately, the viewer's media devices may request a sponsored content segment 42 when those media devices display a program 62.

The program provider 60 operates server 64 to serve programs and to implement usage control system 200. The system 200 may provide an interface that allows the panelist 22 to initiate content requests (e.g., may provide a search engine Web page).

The analytics service 70 may be established to collect information related to Internet content requested by and delivered to the panelist 22. In the example of FIG. 1, the panelist 22 has been recruited and has agreed to such information collection by the analytics service 70. The analytics service 70 may provide the meter 27 established or installed at the viewing location 20.

The analytics service 70 operates analytics server 70, which in turn implements data collection system 300. One aspect of the system 300, as described below, it to provide for capture of secure traffic emanating from the media devices 24 and 26 (i.e. clients) by the meter 27. In an aspect, the system 300 may implement a proxy server as a certificate authority. In another aspect, the system 300 may be used to establish the router 25 as a certificate authority.

In executing the processes of FIG. 1, and as otherwise disclosed herein, individual viewer (panelist) and household demographic data and Internet activity (as well as other media consumption such as and television viewing, for example) may be collected and used. Note that the panelists agree to being measured. Furthermore, individual panelists would agree to sign in to measurement, but any measurement may be suspended at any time (incognito) by a panelist. In situations in which the systems disclosed herein may collect and/or use personal information about panelists, or may make use of personal information, the panelists may be provided with an opportunity to control whether programs or features collect panelist information (e.g., information about a panelist's social network, social actions or activities, profession, a panelist's preferences, or a panelist's current location), or to control whether and/or how to receive media, including advertisements, from an server that may be more relevant or of interest to the panelist. In addition, certain data may be treated in one or more ways before it is stored or used, so that personally identifiable information is removed. For example, a panelist's identity may be treated so that no personally identifiable information can be determined for the panelist, or a panelist's geographic location may be generalized where location information is obtained (such as to a city, ZIP code, or state level), so that a particular location of a panelist cannot be determined. Thus, the panelist may have control over how information is collected about the panelist and used by a server.

FIG. 2A illustrates example relationships among media devices operating in the environment of FIG. 1. FIG. 2A shows three media devices 24, 26, and 28. Media devices 24 and 28 are televisions to which set top boxes (STBs) 34 and 38, respectively, are connected. In effect, one first media device is made up of the combination of television 24 and STB 34, and another first media device is made up of the television 28 and the STB 38. Alternately, the functions of a television and a STB may be combined into a single media device (e.g. a “smart” television). Media devices 24 and 28, and their associated STBs 34 and 38 are in fixed positions in viewing location 20. For example, television 24 is in a living room and television 28 is in a bedroom of a residence (the viewing location 20) of panelist 22. Media device 26 is a mobile, second screen device; in the illustrated example, a tablet. Media device 26 may be registered to the panelist 22 and media devices 24 and 28 may be shared media devices. In FIG. 2A, viewing location 20 is shown with one panelist 22; however the viewing location may have additional (registered) panelists 22.

The media devices 24 (and STB 34), 26, 28 (and STB 38) communicate through network 50 with program provider 60, sponsor 40, and analytics service 70, described above with respect to FIG. 1. This communication with through the network 50 may be by way of router 25. Router 25 may include meter 27.

The media devices 24, 26, 28 all receive programs 62 and may receive sponsored content 42 from program provider 60 and sponsor 40, respectively. In an embodiment, sponsored content 42 provided to the media devices 24, 26, and 28 bears some relationship to the programs 62 currently or previously displayed on the media devices. For example, sponsored content displayed on tablet 26 bears some relationship to programs 62 currently or previously displayed on television 24.

FIG. 2A illustrate an example mechanism to provide the above-described program-sponsored content display relationship among the media devices 24, 26, 28. In FIG. 2A, the example relationship includes audio tone 31, which emanates from STB 34 and may be received by an audio reception device 29 in tablet 26. In addition, the audio reception device 29 may receive program audio 33, which emanates from television 24 during display of programs 62. Similarly, audio reception device 29 may receive audio tone 35 and program audio 37 emanating from STB 38 and television 28, respectively, when the tablet 26 is proximal to the television 28 (e.g., in the same room as the television 28). In an embodiment, the audio reception device 29 is a microphone and connected audio processing components (hardware, firmware, software) and associated storage.

The STBs 34 and 38 may record (log) programs watched information and sponsored content viewed information for programs 62 displayed on at sponsored content served at their respective televisions 24 and 28. The logged data periodically may be sent to a remote service such as the analytics service 70.

The second screen media device, namely tablet 26, which may receive the above-described audio signals, may process the received audio signals and send the thus-processed audio signals as programs watched information to a remote service such as the analytics service, the sponsor 40, and/or the program provider 60.

In FIG. 2A, the media devices 24, 26, and 28 all may be registered (for example as individual or shred media devices) with a panel management company (which may be a component of the analytics service 70). The panelist, as noted above, agrees to being measured. Furthermore, individual panelists at the viewing location would agree to sign in to measurement, but any measurement may be suspended at any time (incognito) by a panelist. Thus, in an embodiment, the analytics service 70 may “know” when the panelist 22 is in a same location as the television 24 and the using tablet 26 because the panelist has signed in with the analytics service 70.

Each STB 34 and 38 has a unique STB identification (STB ID). A STB periodically (e.g., every second) may emit an audio tone, outside the range of human hearing, which encodes the STB's unique STB ID. By detecting and capturing this STB ID, the tablet 26 may be able to provide an association between tablet and television. Further, the tablet 26 may provide information related to this association to a remote service.

FIG. 2B illustrates certain aspects of the relationships illustrated in FIG. 2A. These relationships, as noted above may employ different audio detection and interpretation mechanisms and techniques. A first mechanism and corresponding technique detects a normal audio signal coming from the television during, for example, display of a broadcast television program. The first mechanism may include a microphone installed on the second media device. The microphone detects the audio; programming or logic on the second media device processes and temporarily stores the collected audio signal; other programming or logic creates an audio “fingerprint” of the stored audio. The audio fingerprint may be used to synchronize second media device applications and media measurement. The audio fingerprint may be provided to a remote analytics service to identify the television media that emitted the underlying audio.

A second mechanism and corresponding technique employs tones that are inserted into the broadcast content television media and that then are detected by software in another device. The technique encodes information into the audio tone. In the television STB 34, a tone generator 34B generates the audio tone(s). A tone, or series of tones, may be modulated to contain information about a unique identification of the television STB 34. The tone(s) may encode an identification of the television STB (STB ID). The STB 34 then inserts the tone(s), with the encoded STB ID into the broadcast television stream. The STB may insert the STB ID-bearing tone at regular intervals or on demand.

In an embodiment, the STB 34 may log media consumption data (programs 62 watched, sponsored content 42 served) on the television in STB log 34A. The television STB 34 may provide the logging data to a remote service (analytics service 70, sponsor 40) over a “backchannel.”

At the remote service, the logging data are processed to produce media exposure information (i.e., viewing data related to television programs and advertisements, for example). The remote service may use the media exposure information to create a database of exposures that are linked to the unique STB identification. In this way, the television STB 34, in effect, takes the role of a browser in terms of storing previous visit (viewing) history, and the STB ID takes the role of an Internet “cookie.”

With this database established, and the analogous relationship of the television STB to an Internet browser in place, when a second screen media device (in the above example, a tablet) requests an ad server serve the tablet an advertisement, the tablet acquires the STB ID (the cookie analogy) by one of the example mechanisms disclosed above (e.g., audio sampling and fingerprinting), which encode the STB ID. The tablet then provides the STB ID to the ad server. The ad server uses the STB ID as a key to retrieve television advertisement exposure information as an a priori input to the advertisement selection process.

Certain components of the tablet 26 that cooperate in the above-described process are shown in FIG. 2B. As illustrated, table 26 includes, as audio reception device 29, microphone 29A1, fingerprint engine 29A2, and matching engine 29A3. These components of the device 29 capture both program audio and STB ID, may generate audio fingerprints from the captured program audio, and may perform match processing to identify, in the tablet 26, what program 62 is being watched on the television 24. Alternately, the match processing may be performed at a remote service based on the fingerprints generated on the tablet 26 (and sent in near real time to the remote service).

Also shown as a component of tablet 26 is ad request engine 26B. The engine 26B may send an ad request to the sponsor 40 when an ad availability occurs at the tablet 26. Alternately, the engine 26B may request a series of ad from the sponsor 40, store the ads in memory, and display an appropriate ad when the ad availability occurs.

In selecting ads (i.e., sponsored content 42) to serve at the tablet 26, the sponsor executes ad selection system 46. The ad selection system 46 receives the historical, programs watched information from the STB 34 (e.g., in the form of data from STB log 34A), the unique STB ID for the STB 34, information from meter 27, and uses these data to select an appropriate advertisement to serve at the tablet 26. Thus, panelist 22, signed in as using tablet 26 and viewing television 24 may view sponsored content 42 on tablet 26 based on historical programs watched data collected from programs 62 displayed on television 24.

FIGS. 3A and 3B illustrate example methods of serving sponsored content in the environment of FIG. 1. The methods may be executed by the various processing components of the various devices and servers shown in FIGS. 1, 2A, and 2B, using instructions embodied on non-transitory, computer-readable storage media.

FIG. 3A illustrates method 300, executed at tablet 26. The method 300 begins in block 305 when the tablet 26 receives an audio tone encoded with a unique STB ID for STB 34. The tablet 34 stores the audio tone, indicating that the tablet 26 and the television 24 are proximal to each other. In block 310, the tablet 26 receives program audio emanating from the television 24. The tablet 26 processes the program audio, and may generate audio fingerprints and perform fingerprint matching to identify the program 62 currently displayed on the television 24.

In block 315, the tablet 26 sends an ad request, along with the STB ID (and optionally the program 62 identification) to the sponsor 40. In block 320, the tablet 26 receives an advertisement. The method 300 then ends.

In this way, based on historical programs watched information for the signed-in panelist 22 (at the television 24 and tablet 26), the sponsor 40 is able to select an advertisement to serve at the tablet 26. In other words, the advertisement served at a second screen device is based on a panelist's historical data collected from a first screen device by associating the historical data and the current use of the second screen device. The association takes the form of a “set top box cookie,” analogous to cookies used in an online context.

FIG. 3B is a flowchart illustrating a method parallel method 300 as executed on devices remote from the viewing location 20. In FIG. 3B, method 400 begins in block 405, when sponsor 40 receives an ad request form table 26. In block 410, the sponsor extract the STB ID encoded in the ad request. In block 415, the sponsor 40 consults registration information related to the STB ID and other information included in the ad request to identify the television and tablet, for example.

In block 420, the sponsor 40 consults programs watched information for the television by the signed-in panelist 22. In block 425, the sponsor 40 selects an advertisement to serve at the tablet 26. In block 430, the sponsor sends the selected advertisement to the tablet 26. The method 400 then ends.

Certain of the devices shown in the herein described figures include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAM) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to flowcharts and accompanying descriptions to illustrate the embodiments represented in FIGS. 3A and 3B. The disclosed devices, components, and systems contemplate using or implementing any suitable technique for performing the steps illustrated. Thus, FIGS. 3A and 3B are for illustration purposes only and the described or similar steps may be performed at any appropriate time, including concurrently, individually, or in combination. In addition, many of the steps in the flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices. The computer readable storage medium does not include a transitory signal.

The herein disclosed methods can be implemented as operations performed by a processor on data stored on one or more computer-readable storage devices or received from other sources.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

I claim:

1. A method, executed by a processor, for serving sponsored content at a second media device associated with a first media device, comprising:
receiving by a processor, a unique identification of the first media device;
storing the unique identification with the second media device;
sending, by the processor, a sponsored content request and the unique identification to a sponsor;
receiving, by the processor, sponsored content selected based on historical data related to the content viewed on the first media device.

2. The method of claim 1, wherein the unique identification is embedded in an audio tone generated in association with the first media device.

3. The method of claim 2, wherein the audio tone is outside a range of human hearing.

4. The method of claim 1, wherein the first media device is a television and the second media device is an Internet-capable media device, and wherein at least one unique viewer is exposed to content on both the television and the second media device.

5. The method of claim 4, wherein the second media device receives program audio signals from programs displayed on the first media device, the method, further comprising:
creating, at the processor, audio fingerprints of the program audio; and
sending the audio fingerprints to a remote service.

6. The method of claim 5, wherein the remote service is a sponsor service, and wherein the fingerprints are used to identify a program displayed on the television and to save the identity as programs watched information on the television by the at least one unique viewer.

7. A processor-implemented method to server advertisements to a second media device in association with a first media device, comprising:
receiving, by a processor, programs watched information for programs displayed on the first media device;
receiving, by the processor, an ad request from a second media device, the ad request including a unique identification of the first media device;
retrieving, by the processor, the programs watched information for the first media device; and
selecting, by the processor, an advertisement to serve at the second media device based on the programs watched information for the first media device.

8. The method of claim 7, further comprising:
receiving, by the processor, fingerprints for current programs displayed on the first media device;
analyzing the fingerprints to identify the current programs; and
further basing selection of the advertisement on the identity of the current programs displayed on the first media device.

9. The method of claim 8, wherein the programs are television programs.

10. The method of claim 9, further comprising:
receiving programs watched information from the first media device; and
storing the programs watched information.

11. A system serving sponsored content at a second media device associated with a first media device, comprising:
a processor; and
a computer readable storage medium comprising a program of instructions executable by the processor for serving sponsored content at a second media device associated with a first media device, wherein when the instructions are executed, the processor:
receive a unique identification of the first media device;
store the unique identification with the second media device;
send a sponsored content request and the unique identification to a sponsor;
receive sponsored content selected based on historical data related to the content viewed on the first media device.

12. The system of claim 11, wherein the unique identification is embedded in an audio tone generated in association with the first media device.

13. The system of claim 12, wherein the audio tone is outside a range of human hearing.

14. The system of claim 1, wherein the first media device is a television and the second media device is an Internet-capable media device, and wherein at least one unique viewer is exposed to content on both the television and the second media device.

15. The system of claim 14, wherein the second media device receives program audio signals from programs displayed on the first media device, wherein the processor:
creates audio fingerprints of the program audio; and
sends the audio fingerprints to a remote service.

16. The system of claim 15, wherein the remote service is a sponsor service, and wherein the fingerprints are used to identify a program displayed on the television and to save the identity as programs watched information on the television by the at least one unique viewer.
